(19) United States
(12) Patent Application Publication
(10) Pub. No.: US 2023/0175144 A1
(43) Pub. Date: Jun. 8, 2023

(54) SOLAR DRIVEN AQUACULTURE FARM WITH OXYGEN GENERATION FOR ENHANCED POPULATION HEALTH STABILITY

(71) Applicant: Ohmium International, Inc., Incline Village, NV (US)

(72) Inventor: Arne Ballantine, Incline, NV (US)

(21) Appl. No.: 18/075,123

(22) Filed: Dec. 5, 2022

Related U.S. Application Data
(60) Provisional application No. 63/286,837, filed on Dec. 7, 2021.

(51) Int. Cl. C25B 1/04; A01K 63/04; C25B 15/08; C25B 9/65; C02F 7/00; H01M 8/0656; H01M 10/46; H01M 16/00; C01C 1/04

(52) U.S. Cl. CPC C25B 1/04; A01K 63/042; C25B 15/08; C25B 9/65; C02F 7/00; H01M 8/0656; H01M 10/465; H01M 16/006; C01C 1/0417; C02F 2103/20

(57) ABSTRACT

The present disclosure provides systems and methods for improving production of an aquaculture pond farm. The systems generally include an electrolyzer module to produce hydrogen and oxygen, an ammonia synthesizer operable to receive hydrogen produced by the electrolyzer module, and a diffuser to diffuse oxygen produced by the electrolyzer module in the aquaculture pond farm.

### CROSS-REFERENCE TO RELATED APPLICATION

This application claims benefit of U.S. Provisional Patent Application No. 63/286,837, which was filed in the U.S. Patent and Trademark Office on Dec. 7, 2021, the entire contents of which are incorporated herein by reference for all purposes.

### FIELD OF THE DISCLOSURE

The present disclosure relates to systems and methods for improving production of an aquaculture pond farm. The systems and methods relate to the field of chemistry and chemical engineering.

### BACKGROUND OF THE INVENTION

Aquaculture pond farming has become a viable source of many types of commercial fish and crustaceans such as catfish, bass, trout, and shrimp. These aquaculture pond farms have become popular in recent years due to the commercial need for these fish and crustaceans and a depletion of these species in their natural habitat.

For aquaculture pond farming, a number of factors must be considered to ensure the aquaculture remains vibrant and healthy such as sufficient amounts of dissolved oxygen in the aquaculture pond, sufficient food for the fish and crustaceans, and room to allow fish and crustaceans to grow and reproduce. Out of all the aforementioned factors, the level of dissolved oxygen in an aquaculture farm can be considered the most important. The level of dissolved oxygen in an aquaculture pond is dependent on a number of factors such as the level of nutrients in the aquaculture pond, the amount of water in the aquaculture pond, the temperature of the water in the aquaculture pond, the season of the year, the amount of algae and bacteria present in the aquaculture pond, the amount of organic matter suspended in the aquaculture pond, etc.

Presently, there are a number of methods which are used to increase the amount of dissolved oxygen in an aquaculture farm, such as aerating the water with paddlewheel aerators, low speed surface aerators, floating surface aerators, and fountains. However, these methods fail to significantly increase the oxygen concentration of the aquaculture pond farm.

What is needed are systems and methods which provide health to an aquaculture pond farm by increasing the concentration of oxygen in the aquaculture pond farm.

### SUMMARY OF THE DISCLOSURE

Provided herein are systems for improving production and health quality of an aquaculture pond farm. The systems generally comprise an electrolyzer module to produce hydrogen and oxygen, an ammonia synthesizer fluidly connected to the electrolyzer module and operable to receive hydrogen produced by the electrolyzer module, and a diffuser to diffuse oxygen produced by the electrolyzer module in the aquaculture pond farm.

In some embodiments, the system further comprises a photovoltaic panel electrically connected to the electrolyzer module. In some embodiments, the system further comprises a plurality of photovoltaic panels electrically connected to the electrolyzer module. In some aspects, the system further comprises an energy storage device in electrical communication with the electrolyzer module and/or in electrical communication with the photovoltaic panel. In some additional aspects, the system further comprises a DC/DC converter electrically connected to the photovoltaic panel and to the electrolyzer module.

In some embodiments, the system further comprises an oxygen storage device fluidly connected to the electrolyzer module and to the diffuser. In some aspects, the system further includes a valve fluidly connected to the oxygen storage device and to the diffuser. In some additional aspects, the system further includes an air separator to produce nitrogen and oxygen, the air separator fluidly connected to the oxygen storage device and to the ammonia synthesizer.

In some embodiments, the system further comprises a hydrogen storage system fluidly connected to the electrolyzer module. In some aspects, the hydrogen storage system is fluidly connected to the ammonia synthesizer. In some additional aspects, the hydrogen storage system is fluidly connected to a hydrogen fuel cell. In some examples, the hydrogen fuel cell is electrically connected to the electrical storage device, the electrolyzer module, and the ammonia synthesizer.

In some embodiments, the system further comprises an oxygen sensor which monitors the concentration of oxygen in the aquaculture pond. In some additional embodiments, the system further comprises an aerator to aerate the aquaculture pond farm.

Further provided herein are systems for improving production and health quality of an aquaculture pond farm. The systems generally comprise an electrolyzer module to produce hydrogen and oxygen in electrical communication with a photovoltaic panel, an ammonia synthesizer fluidly connected to the electrolyzer module and operable to receive hydrogen produced by the electrolyzer module, an air separator to produce nitrogen and oxygen fluidly connected to the ammonia synthesizer and an oxygen storage device, and a diffuser to diffuse oxygen produced by the electrolyzer module and the air separator in the aquaculture pond farm.

Further provided herein are methods for improving production and health quality of an aquaculture pond farm. The methods generally comprise producing hydrogen and oxygen in an electrolyzer module, diffusing the produced oxygen in the aquaculture pond farm, and producing ammonia by combining the produced hydrogen with nitrogen in an ammonia synthesizer. In some embodiments, the electrolyzer module is powered by a photovoltaic panel. In some additional embodiments, the method further comprises aerating the aquaculture pond.

In some embodiments, the method further comprises separating nitrogen and oxygen from air in an air separator. In some aspects, the separated nitrogen is combined with the produced hydrogen in the ammonia synthesizer. In some additional aspects, the separated oxygen is diffused in the aquaculture pond farm.

Other features and iterations of the invention are described in more detail below.

### BRIEF DESCRIPTION OF THE FIGURES

FIG. 1 is a block diagram of an exemplary system of the present disclosure.

FIG. 2 is a block diagram of an exemplary system of the present disclosure.

### DETAILED DESCRIPTION OF THE DISCLOSURE

Described herein are systems for enhancing production and increasing the health stability of an aquaculture pond farm. This enhanced production relates to increasing and maintaining the level of oxygen in the aquaculture pond through an aerator and a diffuser using renewable energy. The oxygen produced in a hydrogen electrolyzer is used to increase the oxygen concentration, rather than being released to the atmosphere. Additionally, the hydrogen produced in the system can be used for energy storage or other uses. Further, as will be appreciated by those having skill in the art, the presence of an oxygen-rich atmosphere around an electrolyzer that produces hydrogen gas has a high risk of explosion. Since the hydrogen and oxygen gases are separated and not released to the atmosphere, the risk of explosion is minimized. Thus, the systems of the present disclosure may further improve safety by removing oxygen from the system and incorporating the oxygen directly into an aquaculture pond farm.

As used herein, the terms “aquaculture pond” and “aquaculture pond farm” may be used interchangeably. An aquaculture pond may include a natural body of water or a man-made body of water. The aquaculture pond may include an open vessel (e.g., a tank), a closed vessel, or a reactor suitable for aquaculture. The aquaculture pond may contain saltwater or freshwater. Aquaculture ponds and methods of making or constructing aquaculture ponds are generally known in the art.

The aquaculture pond farm may be operable to raise aquaculture animals, aquaculture plants, aquaculture microorganisms, and combinations thereof. The aquaculture pond farm may be operable to raise a variety of aquaculture species and combinations thereof, including fish (e.g., carp, tilapia, salmon, milkfish, trout, bream, catfish, bass, yellowtail, pompano, etc.), crustaceans (e.g., shrimp, krill, crab, lobster, clams, oysters, mussels, etc.), algae (e.g., phytoplankton, purple laver, dulse, spirulina, chlorella, Irish moss, sea lettuce, dabberlocks, seaweed, etc.), and other species known to those having ordinary skill in the art. In a particular embodiment, the aquaculture pond farm of the present disclosure is operable to raise shrimp.

The system comprises an electrolyzer module. The electrolyzer module comprises an electrolyzer stack operable to convert water into gaseous oxygen and hydrogen. Electrolyzer stacks (also referred to as electrochemical stacks) and methods of making and procuring electrolyzer stacks are generally known in the art. In particular, electrolyzer modules suitable for use in the system of the present disclosure are described in U.S. application Ser. No. 17/101,232 (issued as U.S. Pat. No. 11,492,711) entitled “ELECTROCHEMICAL DEVICES, MODULES, AND SYSTEMS FOR HYDROGEN GENERATION AND METHODS OF OPERATING THEREOF”, the entire contents of which are incorporated by reference herein in their entirety. In some embodiments, the system may comprise a plurality of electrolyzer modules.

The electrolyzer module may comprise a membrane electrolyte such as a proton exchange membrane (PEM). The PEM may comprise any suitable proton exchange (e.g., hydrogen ion transport) polymer membrane, such as Nafion® membrane composed of sulfonated tetrafluoroethylene based fluoropolymer-copolymer having a formula C₇HF₁₃O₅S·C₂F₄.

The electrolyzer module may further comprise power electronics. The power electronics may be formed or provided in a single assembly that connects input energy (e.g., from the photovoltaic panel), the electrolyzer stack, and/or additional energy outputs or energy loads. The power electronics may be operable to connect to DC energy inputs, AC energy inputs, and combinations thereof. The power electronics may further be operable to connect to DC energy loads, AC energy loads, and combinations thereof. The power electronics may comprise a GaN inverter board, an integrated power board, control cards, a display board, and/or a DAB converter, one or more transformers, one or more rectifiers, etc.

The electrolyzer module comprises an inlet operable to receive water from a water source; for example, a water capture system (e.g., rainwater capture), tap water, a municipal water supply, and/or a natural body of water. The inlet may therefore be fluidly connected to the water source. In some embodiments, the water source may be the aquaculture pond itself.

The water from the water source may be pumped to the electrolyzer module via an input water pump from the water source to the inlet of the electrolyzer module. The water may be pumped at a sufficient pressure to be usable by the electrolyzer module. The input water pump may be any pump known in the art suitable for pumping water, such as a centrifugal pump, a positive-displacement pump, or an axial-flow pump. The input water pump may receive power from a photovoltaic panel, a hydrogen fuel cell, and/or an energy storage system.

The electrolyzer module comprises a first outlet operable to deliver oxygen to the aquaculture pond. Preferably, the first outlet is fluidly connected to a diffuser, which diffuses the oxygen into the aquaculture pond. The electrolyzer module may generate oxygen at a rate of about 1 kg/hr or greater. For example, the oxygen may be generated at a rate of about 1 kg/hr or greater, about 10 kg/hr or greater, about 25 kg/hr greater, about 50 kg/hr or greater, or about 100 kg/hr or greater. Thus, the oxygen may be delivered to the diffuser at a rate of about 1 kg/hr or greater, about 10 kg/hr or greater, about 25 kg/hr greater, about 50 kg/hr or greater, or about 100 kg/hr or greater.

The diffuser may be operable to disperse the oxygen in the aquaculture pond such that the oxygen is dissolved in the aquaculture pond water. Devices for diffusing oxygen in water and methods of making and procuring the same are generally known in the art. The diffuser may comprise a microbubble diffuser, an atomizer, a sparser, coarse bubble aerators, fine bubble aerators, or other devices suitable for diffusing oxygen in water. The system may comprise a plurality of diffusers at multiple locations to more evenly distribute the oxygen in the aquaculture pond. After the diffuser diffuses oxygen into the water, the water may be referred to as oxygenated water.

The system may further comprise an output water pump. The output water pump may be operable to circulate or otherwise distribute oxygenated water to the aquaculture pond farm. For example, after the diffuser diffuses oxygen into a portion of the aquaculture pond water, the oxygenated portion of the water may be pumped via the output water pump to more evenly distribute the oxygen throughout the aquaculture pond farm. The output water pump may receive power from a photovoltaic panel, a hydrogen fuel cell, and/or an energy storage system.

The electrolyzer module also comprises a second outlet operable to deliver hydrogen to a hydrogen load. The second outlet may be fluidly connected to the hydrogen load. Alternatively, the second outlet may be fluidly connected to a proton conducting hydrogen pump, which is fluidly connected to the hydrogen load. The hydrogen load may include a hydrogen storage system, a hydrogen fuel cell, a combustion system, and combinations thereof. Examples of these hydrogen loads are generally known in the art.

The hydrogen gas flowing from the electrolyzer module through the second outlet preferably consists essentially of hydrogen and water. The hydrogen flowing from the electrolyzer module may have a purity of about 95% to about 98% by weight.

The system may further comprise a photovoltaic panel or a plurality of photovoltaic panels. The photovoltaic panel is preferably electrically connected to the electrolyzer module and provides electricity to the electrolyzer module such that the electrolyzer module may perform electrolysis. The photovoltaic panel is also preferably electrically connected to an energy storage device, the ammonia synthesizer, and/or the air separator, as well as other system components requiring electricity. The photovoltaic panel may be mounted on a tracker to optimize production of electricity throughout the day. Photovoltaic panels and methods of making and procuring photovoltaic panels are generally known to those having ordinary skill in the art.

The electrolyzer module may further comprise a proton conducting hydrogen pump. The proton conducting hydrogen pump (also referred to herein as a “hydrogen pump”) may be, for example, an electrochemical pump. As used in this context, an electrochemical pump shall be understood to include a proton exchange membrane (i.e., a PEM electrolyte) disposed between an anode and a cathode. The proton exchange membrane may be any proton exchange membrane discussed herein. The hydrogen pump may generate protons moveable from the anode through the proton exchange membrane to the cathode form pressurized hydrogen. Thus, the hydrogen pump may be operable to provide pressurized hydrogen produced by the electrolyzer module to a hydrogen load. The hydrogen pump may be fluidly connected to the electrolyzer module and to a hydrogen load.

The hydrogen pump may be operable to improve the purity of the hydrogen. For example, the hydrogen flowing from the hydrogen pump may have a purity of about 98% to about 99.999%, such as from about 98% to about 99%, about 98% to about 99.9%, about 98% to about 99.99%, about 98% to about 99.999%, about 99% to about 99.999%, about 99.9% to about 99.999%, or about 99.99% to about 99.999%. The major impurities of the hydrogen flowing from the hydrogen pump may include oxygen and water.

In particular, hydrogen pumps suitable for use in the system of the present disclosure are described in U.S. application Ser. No. 17/101,232 entitled “ELECTROCHEMICAL DEVICES, MODULES, AND SYSTEMS FOR HYDROGEN GENERATION AND METHODS OF OPERATING THEREOF”, the entire contents of which are incorporated by reference herein in their entirety.

The system may further comprise a dryer fluidly connected to the hydrogen pump and/or fluidly connected to the electrolyzer module. The dryer may be, for example, a pressure swing adsorption (PSA) system, a temperature swing adsorption (TSA) system, a hybrid PSA-TSA system, or a membrane purifier. The dryer may include one or more beds of a water-adsorbent material, such as activated carbon, silica, zeolite or alumina. The dryer may include a membrane such as a PEM electrolyte. The dryer may comprise an inlet portion and an outlet portion. The inlet portion is operable to receive hydrogen from the electrolyzer module. The inlet portion of the dryer may therefore be fluidly connected to the hydrogen pump. The inlet hydrogen gas may have a purity of about 95% to about 98%, wherein the major impurity is water. The outlet portion is operable to provide dry hydrogen to a hydrogen load, and therefore may be fluidly connected to a hydrogen load. The dryer may also comprise a second outlet comprising low pressure hydrogen, e.g., from about 1 bar to about 2 bar, or less than about 1 bar.

The dryer may further comprise a purge stream. The purge stream is operable to remove excess water vapor and other gases, including oxygen, from the hydrogen produced in the electrolyzer module. The purge stream may comprise hydrogen having a concentration from about 5% to about 25%, or more preferably less than 5%. The balance of the purge stream may comprise water and oxygen. The purge stream may be fluidly connected to the aquaculture pond or to the atmosphere.

The system may further comprise an aerator. The aerator is operable to incorporate air (i.e., oxygen) into the water of the aquaculture pond farm. It will therefore be understood that as used herein, aerators differ from diffusers in that the oxygen source for the aerator is air, whereas the oxygen source for diffusers described herein is purified oxygen generated by the electrolyzer module and/or the air separator. Aerators and methods for aeration are generally known in the art and may include surface aerators such as fountains, paddlewheel aerators, floating surface aerators, and the like, as well as subsurface aerators including jet aerators, coarse bubble aerators, fine bubble aerators, and the like.

The system may further comprise a hydrogen storage system or hydrogen storage device. The hydrogen storage system may be fluidly connected to the electrolyzer module and to a hydrogen load, such as a hydrogen fuel cell. The hydrogen may be stored at a pressure from about 10 bar to about 800 bar; for example, about 10 bar, about 50 bar, about 100 bar, about 150 bar, about 200 bar, about 250 bar, about 300 bar, about 350 bar, 400 bar, 450 bar, 500 bar, 550 bar, 600 bar, 650 bar, about 700 bar, about 750 bar, or about 800 bar. The pressurized hydrogen may be stored at a pressure from about 10 bar to about 50 bar, about 10 bar to about 100 bar, about 10 bar to about 200 bar, about 10 bar to about 300 bar, about 10 bar to about 400 bar, about 10 bar to about 500 bar, about 10 bar to about 600 bar, about 10 bar to about 700 bar, about 10 bar to about 800 bar, about 100 bar to about 800 bar, about 200 bar to about 800 bar, about 300 bar to about 800 bar, about 400 bar to about 800 bar, about 500 bar to about 800 bar, about 600 bar to about 800 bar, about 700 bar to about 800 bar, about 300 bar to about 700 bar, or about 300 bar to about 600 bar. In some examples, the hydrogen may be stored at a pressure of about 350 bar, about 550 bar, or about 700 bar. One or more hydrogen pumps may be used to pressurize the hydrogen. Alternatively, other devices and systems to increase the pressure of hydrogen may be used, such as a compressor. The hydrogen may be stored on a short term basis (minutes or hours) or a long term basis (days, weeks, months, or more).

The hydrogen load may comprise a hydrogen fuel cell. The hydrogen fuel cell may be operable to produce electricity by combining hydrogen produced by the electrolyzer module and oxygen from the air to form water. Hydrogen fuel cells and methods of making and procuring hydrogen fuel cells are generally well known in the art. Preferably, the hydrogen fuel cell is a proton-exchange membrane fuel cell.

The hydrogen fuel cell may be in electrical communication with the electrolyzer module, the air separator, the aerator, the ammonia synthesizer, and other components of the system requiring electrical power. The hydrogen fuel cell may also be in fluid communication with the electrolyzer module and/or a hydrogen storage system. Preferably, the hydrogen fuel cell is in fluid communication with a hydrogen storage system and is operable to produce electricity at times when the photovoltaic panel is not producing electricity or is producing an insufficient amount of electricity.

The hydrogen load may comprise farm equipment such as trucks, tractors, boats, and other vehicles or equipment powered by a hydrogen fuel cell.

The system further may further comprise an energy storage device. The energy storage device may provide electricity to the system during times when the photovoltaic panel cannot produce electricity or produces an insufficient amount of electricity (e.g., when the sun is not shining or during maintenance) to meet system requirements. The energy storage device may comprise any mechanism or apparatus operable to store and distribute electricity. For example, the energy storage device may include batteries (e.g., lead-acid batteries, lithium ion batteries, lithium iron batteries, etc.), compressed air, pumped hydroelectric, or other energy storage devices known in the art and combinations thereof. Preferably, the energy storage device includes batteries. The energy storage device may be electrically connected to the electrolyzer module, to the aerator, to the ammonia synthesizer, to the air separator, and/or to any of the other system components described herein.

The system may further comprise an auxiliary power source. The auxiliary power source may be electrically connected to any one or more of the system components described herein. The auxiliary power source may be used to supplement the electricity provided by the photovoltaic panel to meet system requirements and/or to charge the energy storage device. The auxiliary power source may include a renewable energy source such as wind power, tidal power, wave power, geothermal power, hydroelectric power, and other renewable energy sources known in the art and combinations thereof. In a particular embodiment, the auxiliary power source may include a hydrogen fuel cell, as further described hereinabove. The auxiliary power source may alternatively or additionally comprise a power grid, such as a regional power grid, a municipal power grid, or a micro grid. Although less preferable, the auxiliary power source may comprise non-renewable sources such as coal and natural gas.

The electrolyzer module and other system components may receive electricity from an intermittent source such as solar power (i.e., through the photovoltaic panel), the energy storage device, the auxiliary power source, or a combination thereof. In order to condition the energy received the photovoltaic panel, the photovoltaic panel may be electrically connected to a DC/DC converter. The energy storage device and/or the auxiliary power source may also be electrically connected to the DC/DC converter.

The system may further comprise at least one valve fluidly connected to the first outlet of the electrolyzer module and the diffuser. The at least one valve may be operable to direct the flow of oxygen to the diffuser and thus to the aquaculture pond. Thus, the valve is operable to modify the flow rate of the oxygen to the aquaculture pond. Additionally, the valve may be operable to direct the flow of oxygen to an oxygen storage device or to another oxygen load. The valve may be any valve known to those having ordinary skill in the art, such as solenoid valve, control valve, flow regulating valve, back pressure regulating valve, y-type valve, piston valve, pressure regulating valve, or a check valve.

The system may further comprise an oxygen storage device or an oxygen storage system. Devices and systems for storing oxygen are generally known in the art. The oxygen may be stored on a short term basis (minutes or hours) or a long term basis (days, weeks, months, or more). The oxygen storage device may be fluidly connected to the electrolyzer module to receive the oxygen produced by the electrolyzer module. The oxygen storage device may also be fluidly connected to a diffuser to diffuse the stored oxygen into the aquaculture pond.

The at least one valve may be electrically connected to a controller and/or to an oxygen sensor. The at least one valve may increase or decrease the flow rate of the oxygen to the aquaculture pond based on instructions received from the controller. This may be accomplished by opening or closing the valve in response to a signal received from the controller. The flow rate of oxygen may be modified according to a predetermined schedule, in response to the oxygen concentration in the aquaculture pond reaching a predetermined threshold concentration, or in response to a direct request from a client or customer.

The at least one valve may modify the flow rate of oxygen to the aquaculture pond such that the concentration of oxygen in the aquaculture pond is from about 1 mg/L to about 20 mg/L or greater. For example, the concentration of oxygen in the aquaculture pond may be from about 1 mg/L to about 5 mg/L, about 1 mg/L to about 10 mg/L, about 1 mg/L to about 15 mg/L, about 1 mg/L to about 20 mg/L, about 5 mg/L to about 10 mg/L, about 5 mg/L to about 15 mg/L, about 5 mg/L to about 20 mg/L, about 10 mg/L to about 20 mg/L, or about 15 mg/L to about 20 mg/L. In another example, the concentration of oxygen in the aquaculture pond may be about 1 mg/L, about 2 mg/L, about 3 mg/L, about 4 mg/L, about 5 mg/L, about 6 mg/L, about 7 mg/L, about 8 mg/L, about 9 mg/L, about 10 mg/L, about 11 mg/L, about 12 mg/L, about 13 mg/L, about 14 mg/L, about 15 mg/L, about 16 mg/L, about 17 mg/L, about 18 mg/L, about 19 mg/L, or about 20 mg/L.

Preferably, the oxygen concentration in the aquaculture pond farm is at least 4.5 mg/m L. Those having ordinary skill in the art will appreciate that an optimal oxygen concentration for the aquaculture farm may be determined based on the aquaculture being raised (animal, plant, microorganism, etc.), the size of the aquaculture pond, the number of individual organisms being raised, etc.

The system may further comprise an oxygen sensor that may be electrically connected the controller and/or to the valve. The oxygen sensor is operable to determine the concentration of oxygen in the aquaculture pond. In some embodiments, the aquaculture pond may include a plurality of oxygen sensors. Oxygen sensors and methods of making and procuring oxygen sensors are generally well-known to those having ordinary skill in the art. In some embodiments, the system may comprise a plurality of oxygen sensors. Preferably, the oxygen sensor has a sensitivity of at least about 1 mg/L, at least about 0.5 mg/mL, at least about 0.1 mg/mL, or at least about 0.01 mg/mL.

The valve may modify the flow rate of oxygen to the water supply such that the saturation of oxygen in the water supply is from about 20% to about 90%.

The system may increase the oxygen concentration of the aquaculture pond by about 10% to about 50%.

The system may further comprise a controller. The controller may be electrically connected to one or more of the system components described hereinabove. The controller is operable to adjust various parameters of the system and the components of the system based on various inputs received, such as temperature, flow rate, pressure, current, etc. The controller may also be operable to turn one or more system components off and on.

The system further comprises an air separator operable to separate nitrogen and oxygen from the air. Air separators and methods of making and procuring air separators are generally known to those having ordinary skill in the art. The air separator may comprise a cryogenic air separator (e.g., cryogenic distillation) or a non-cryogenic air separator (e.g., pressure swing adsorption, vacuum swing adsorption, membrane separators, etc.). The air separator may be fluidly connected to an oxygen storage device or the diffuser, which may then diffuse the separated oxygen into the aquaculture pond farm water. The air separator may also be fluidly connected to the ammonia synthesizer to provide nitrogen gas for the ammonia synthesis. Preferably, the air separator is electrically connected to the photovoltaic panel, the hydrogen fuel cell, and/or the energy storage system for input electricity. In this arrangement, the air separator may draw power from the photovoltaic panel during the day when the photovoltaic panel is producing electricity and draw power from the hydrogen fuel cell and/or the energy storage system at night when the photovoltaic panel is not producing electricity.

The system may further comprise an ammonia synthesizer. The ammonia synthesizer converts hydrogen gas produced by the electrolyzer module and nitrogen gas produced in the air separator into ammonia. The produced ammonia may be gaseous or liquid ammonia. The gaseous or liquid ammonia can be sold as fertilizer by the farmer or used by the farmer as a low-cost fertilizer on a farm owned or leased the aquaculture farmer. The energy for the ammonia synthesizer is supplied by the energy storage device, the hydrogen fuel cell, and/or the photovoltaic panel; thus, the ammonia synthesizer may be electrically connected to the energy storage device, the hydrogen fuel cell, and/or the photovoltaic panel.

Ammonia synthesizers and methods of synthesizing ammonia are generally known to those having ordinary skill in the art. The ammonia synthesizer may synthesize ammonia via a Haber Bosch process, wherein the hydrogen produced by the electrolyzer module is catalytically reacted with nitrogen produced in the air separator. In particular embodiments, the ammonia synthesizer may include an ammonia synthesis system as described in U.S. application Ser. No. 17/101,224 entitled “SYSTEMS AND METHODS OF AMMONIA SYNTHESIS”, filed on Nov. 23, 2020, the entire contents of which are incorporated by reference herein. Preferably, the ammonia synthesizer comprises an electrochemical reactor, the energy source of which includes a proton exchange membrane cell.

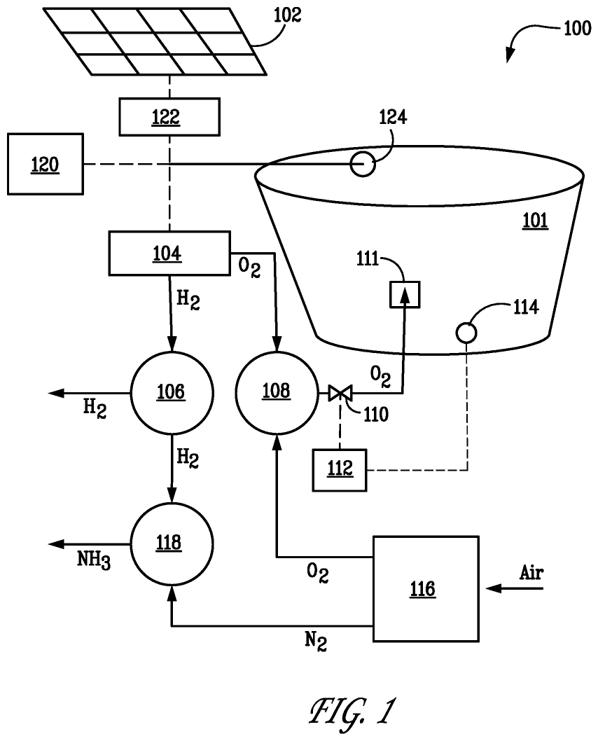

Referring now to FIG. 1, an embodiment of the system 100 of the present disclosure includes a photovoltaic panel 102 electrically connected to a DC/DC converter 122 to provide electricity to an electrolyzer module 104, an aerator 124, and an energy storage system 120. The aerator 124 is operable to increase the oxygen concentration of the aquaculture pond 101. The photovoltaic panel 102 is electrically connected to the electrolyzer module 104, the energy storage system 120, and the aerator 124. Thus, when receiving sunlight, the photovoltaic panel 102 may provide electricity to the electrolyzer module 104, the energy storage system 120, the aerator 124, or a combination thereof. The electrolyzer module 104 produces hydrogen gas and oxygen gas using the electricity received from the photovoltaic panel 102 and/or the energy storage system 120. The energy storage system 120 is electrically connected to the electrolyzer module 104 to provide additional electricity when needed, such as when the system 100 is not receiving sunlight.

The oxygen gas produced in the electrolyzer module 104 is provided to an oxygen storage device 108. The oxygen storage device 108 then provides oxygen to the aquaculture pond 101. The oxygen is diffused into the aquaculture pond 101 via a diffuser 111. An oxygen sensor 114 determines the oxygen concentration of the water in the aquaculture pond 101. A valve 110 controls the flow rate of the oxygen via a controller 112, which receives an electrical signal from the oxygen sensor 114.

The hydrogen gas produced in the electrolyzer module 104 is provided to a hydrogen storage system 106. The stored hydrogen may be provided to a hydrogen load such as farm equipment powered by a hydrogen fuel cell. The hydrogen gas is also provided to an ammonia synthesizer 118 to produce ammonia.

An air separator 116 receives air from the ambient environment and produces oxygen gas and nitrogen gas. The oxygen gas is provided to the oxygen storage device 108 to be diffused into the aquaculture pond 101. The nitrogen is provided to the ammonia synthesizer 118 to produce ammonia. The ammonia may be used as fertilizer or to produce fertilizer.

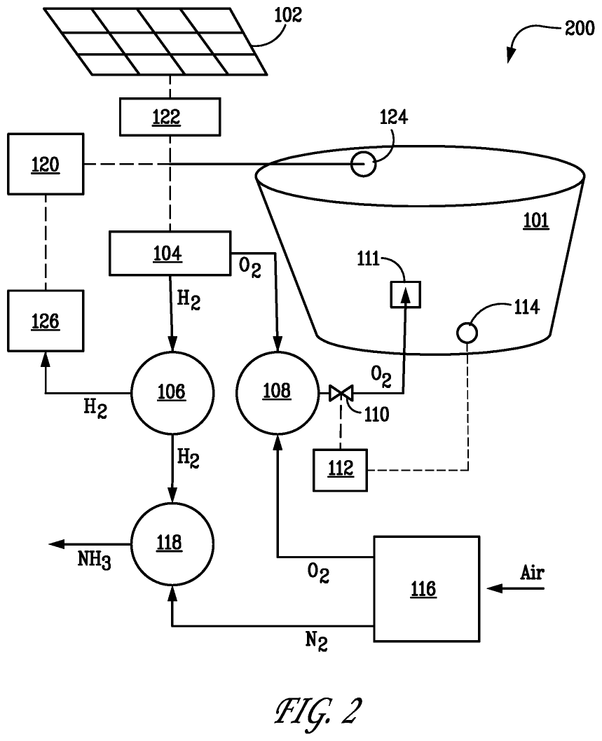

Referring now to FIG. 2, an embodiment of the system 200 of the present disclosure includes a photovoltaic panel 102 electrically connected to a DC/DC converter 122 to provide electricity to an electrolyzer module 104, an aerator 124, and an energy storage system 120. The aerator 124 is operable to increase the oxygen concentration of the aquaculture pond 101. When receiving sunlight, the photovoltaic panel 102 may provide electricity to the electrolyzer module 104, the energy storage system 120, the aerator 124, or a combination thereof. The electrolyzer module 104 produces hydrogen gas and oxygen gas using the electricity received from the photovoltaic panel 102 and/or the energy storage system 120. The energy storage system 120 is electrically connected to the electrolyzer module 104 to provide additional electricity when needed, such as when the system 200 is not receiving sunlight.

The oxygen gas produced in the electrolyzer module 104 is provided to an oxygen storage device 108. The oxygen storage device 108 then provides oxygen to the aquaculture pond 101. The oxygen is diffused into the water in the aquaculture pond 101 via a diffuser 111. An oxygen sensor 114 determines the oxygen concentration of the water in the aquaculture pond 101. A valve 110 controls the flow rate of the oxygen via a controller 112, which receives an electrical signal from the oxygen sensor 114.

The hydrogen gas produced in the electrolyzer module 104 is provided to a hydrogen storage system 106. The stored hydrogen is provided to the hydrogen fuel cell 126 to produce electricity. The electricity produced by the hydrogen fuel cell 126 is provided to the energy storage system 120. The stored hydrogen gas is also provided to an ammonia synthesizer 118 to produce ammonia.

An air separator 116 receives air from the ambient environment and produces oxygen gas and nitrogen gas. The oxygen gas is provided to the oxygen storage device 108 to be diffused into the aquaculture pond 101. The nitrogen is provided to the ammonia synthesizer 118 to produce ammonia. The ammonia may be used as fertilizer or to produce fertilizer.

Further provided herein are methods for increasing production and enhancing the health stability of an aquaculture pond farm. The methods are generally accomplished using the systems described herein. The methods generally include producing hydrogen and oxygen in an electrolyzer module, diffusing the produced oxygen in the aquaculture pond farm, and producing ammonia by combining the produced hydrogen with nitrogen in an ammonia synthesizer. The electrolyzer module may be any electrolyzer module described herein, and the ammonia synthesizer may be any ammonia synthesizer described herein. The electrolyzer module and/or the ammonia synthesizer may be powered via a photovoltaic panel, a hydrogen fuel cell, an energy storage device, or a combination thereof as described herein.

The method may further include separating nitrogen and oxygen from air in an air separator. The air separator may be any air separator described herein. The nitrogen produced in the air separator may be combined with the hydrogen produced by the electrolyzer module to produce ammonia. The oxygen produced in the air separator may also be diffused in the aquaculture pond farm water. The air separator may be powered via a photovoltaic panel, a hydrogen fuel cell, an energy storage device, or a combination thereof as described herein.

The method may further comprise detecting the oxygen concentration in the water of the aquaculture pond farm via an oxygen sensor. The oxygen sensor may be any oxygen sensor described herein. In particular embodiments, the method may further include increasing or decreasing the flow rate of oxygen produced by the electrolyzer module in response to the oxygen concentration detected by the oxygen sensor. The flow rate may increase or decrease by opening or closing a valve fluidly connected to the electrolyzer module. The valve may open and close in response to an electrical communication received from a controller as described herein. For example, if the oxygen concentration reaches a predetermined maximum value, the valve may close to reduce the flow rate of oxygen entering the aquaculture pond. Alternatively, the valve may redirect a portion of the oxygen to an oxygen storage device or an oxygen load; therefore, the method may further comprise storing the produced oxygen in an oxygen storage device. As another example, if the oxygen concentration reaches a predetermined minimum value, the valve may open to increase the flow rate of oxygen entering the aquaculture pond.

The method may further include aerating the aquaculture pond farm using an aerator as described herein. Preferably, the aerator may be powered via a photovoltaic panel, a hydrogen fuel cell, an energy storage device, or a combination thereof as described herein.

The method may further include powering farm equipment using the produced hydrogen. This may be useful when farm equipment, such as cars, trucks, tractors, etc., is powered by a hydrogen fuel cell. Alternatively, the farm equipment may be electrically powered. In this case, the farm equipment may be charged via a photovoltaic panel, or the hydrogen may be used to produce electricity in a hydrogen fuel cell to charge the electrically powered farm equipment.

The method may further include using the ammonia produced in the ammonia synthesizer to produce fertilizer. Alternatively, the ammonia produced in the ammonia synthesizer may be used directly as a fertilizer.

### Definitions

As used herein, a “fluid” connection is a connection that allows for or facilitates the transfer of fluids including liquids and gases. Non-limiting examples of fluid connections include pipes, manifolds, ducts, valves, hoses, couplings, tubes, etc.

As used herein, an “electrical” connection is a connection that allows for or facilitates the transfer of electricity. Non-limiting examples of electrical connections include wires, cables, power lines, breakers, transformers, converters, rectifiers, switches, etc.

As used herein, an “operable” connection includes any connection that allows for or facilitates the operation of a system unit or process. An operable connection may include an electrical connection and/or a fluid connection.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for improving production of an aquaculture pond farm, the system comprising:
an electrolyzer module to produce hydrogen and oxygen;
an ammonia synthesizer fluidly connected to the electrolyzer module and operable to receive hydrogen produced by the electrolyzer module; and
a diffuser to diffuse oxygen produced by the electrolyzer module in the aquaculture pond farm.

2. The system of claim 1, further comprising an oxygen storage device fluidly connected to the electrolyzer module and to the diffuser.

3. The system of claim 2, further comprising a valve fluidly connected to the oxygen storage device and to the diffuser.

4. The system of claim 2, further comprising an air separator to produce nitrogen and oxygen fluidly connected to the oxygen storage device and to the ammonia synthesizer.

5. The system of claim 1, further comprising a hydrogen storage system fluidly connected to the electrolyzer module.

6. The system of claim 5, wherein the hydrogen storage system is fluidly connected to the ammonia synthesizer.

7. The system of claim 5, wherein the hydrogen storage system fluidly connected to a hydrogen fuel cell.

8. The system of claim 7, wherein the hydrogen fuel cell is electrically connected to the electrical storage device, the electrolyzer module, and the ammonia synthesizer.

9. The system of claim 1, further comprising a photovoltaic panel electrically connected to the electrolyzer module.

10. The system of claim 9, further comprising an energy storage device in electrical communication with the electrolyzer module.

11. The system of claim 9, further comprising a DC/DC converter electrically connected to the photovoltaic panel and to the electrolyzer module.

12. The system of claim 1, further comprising an oxygen sensor which monitors the concentration of oxygen in the aquaculture pond farm.

13. The system of claim 1, further comprising an aerator to aerate the aquaculture pond farm electrically connected to the photovoltaic panel.

14. A system for improving production of an aquaculture pond farm, the system comprising:
an electrolyzer module to produce hydrogen and oxygen in electrical communication with a photovoltaic panel;
an ammonia synthesizer fluidly connected to the electrolyzer module and operable to receive hydrogen produced by the electrolyzer module;
an air separator to produce nitrogen and oxygen fluidly connected to the ammonia synthesizer and an oxygen storage device; and
a diffuser to diffuse oxygen produced by the electrolyzer module and the air separator in the aquaculture pond farm.

15. A method for improving production of an aquaculture pond farm comprising:
producing hydrogen and oxygen in an electrolyzer module;
diffusing the produced oxygen in the aquaculture pond farm; and
producing ammonia by combining the produced hydrogen with nitrogen in an ammonia synthesizer.

16. The method of claim 15, further comprising separating nitrogen and oxygen from air in an air separator.

17. The method of claim 16, wherein the separated nitrogen is combined with the produced hydrogen in the ammonia synthesizer.

18. The method of claim 16, wherein the separated oxygen is diffused in the aquaculture pond farm.

19. The method of claim 15, wherein the electrolyzer module is powered by a photovoltaic panel.

20. The method of claim 15, further comprising aerating the aquaculture pond.
